(19) United States
(12) Patent Application Publication
(10) Pub. No.: US 2026/0262664 A1
(43) Pub. Date: Sep. 10, 2026

(54) HYDROPHOBIC GAS BARRIER COATING

(71) Applicant: NABACO INC., San Marcos, TX (US)

(72) Inventor: Gary BEALL, San Marcos, TX (US)

(73) Assignee: NABACO INC., San Marcos, TX (US)

(21) Appl. No.: 19/165,117

(22) PCT Filed: Mar. 13, 2024
(86) PCT No.: PCT/IB2024/052429

§ 371 Date: Sep. 13, 2025

Related U.S. Application Data
(60) Provisional application No. 63/451,810, filed on Mar. 13, 2023.

(51) Int. Cl. A23B 7/16

(52) U.S. Cl. CPC A23B 7/16

(57) ABSTRACT

There is provided a thixotropic composition that forms a hydrophobic gas barrier coating on the surface of an agricultural product, such as produce, or the surface of packaging materials, such as packaging materials used to package agricultural products, for protecting from dehydration and/or from oxidation, and/or for preventing oxygen ingress and/or water loss through a packaging material. The thixotropic composition comprises a smectite clay, a compatibilizing agent, an oil and/or wax, and a solvent comprising a volatile solvent. Also provided is methods for making the composition, methods for applying the composition to a hydrophobic surface, and uses of the composition.

### FIELD OF THE INVENTION

The present invention is directed to a composition that forms a transparent hydrophobic gas barrier coating on hydrophobic surfaces, such as the surface of an agricultural product (e.g., food products, such as produce, which includes fruit and vegetables; or cut flowers) or the surface of packaging materials, such as packaging materials typically used to package agricultural products. The composition is effective for protecting an agricultural product from dehydration and/or from oxidation, and/or for preventing oxygen ingress and/or water loss through a packaging material. The invention also relates generally to methods for making the composition, methods for applying the composition to a hydrophobic surface, and uses of the composition, as described herein.

### BACKGROUND OF THE INVENTION

Many hydrophobic surfaces would benefit from having a coating that acts as a barrier to the movement of gases and/or water. These surfaces include but are not limited to the surfaces of fruits such as pome fruits or tomatoes, cut flowers such as roses, and packaging materials such as oriented polypropylene (PP) and polyethylene (PE).

Fruit and vegetable produce are frequently stored for long periods of time and are often shipped long distances prior to their final point of sale to the consumer. This can lead to problems if the produce ripens quickly or is prone to damage during transit. Overripe or damaged fruits and vegetables often cannot be sold or consumed, resulting in large amounts of waste. Therefore, it would be desirable to improve the shelf life of the products by increasing the length of time that the produce may be stored prior to consumption, by preventing premature ripening, damage, and/or spoilage of the produce.

In the case of fruits and cut flowers, their shelf life is adversely affected by loss of water and oxidation from the air. In the case of PP and PE packaging materials, they are very good at stopping water migration into or out of the food. However, they are very poor oxygen barriers. For example, the packaging of meat prevents the meat from dehydrating, while in a product like Pop-Tarts® the ingress of water is prevented by the packaging. These packaging materials often are augmented with an aluminized coating to overcome the poor oxygen barrier. The aluminized coating is expensive and makes the packaging opaque. However, consumers would prefer to be able to view most products before purchase.

The presently disclosed invention provides a solution to the problem that agricultural products such as produce or cut flowers, and their packaging materials, require protection from oxygen in addition to egress or ingress of water.

### SUMMARY OF THE INVENTION

The invention relates generally to a composition that consists of or comprises a thixotropic mixture. Accordingly, the compositions of the invention are thixotropic compositions. The terms “thixotropic mixture” and “thixotropic composition” are used interchangeably herein to refer to compositions of the invention that are thixotropic. In some aspects of the invention, the thixotropic composition consists of or comprises at least one smectite clay, a compatibilizing agent for hydrophobically-modifying the smectite clay, an oil and/or wax, and a solvent comprising a volatile solvent. In other aspects, the smectite clay is hydrophobically-modified (e.g., by the action of a compatibilizing agent) and therefore a compatibilizing agent is not required, or is not present in the mixture. Accordingly, in these other aspects, the invention provides a thixotropic composition that consists of or comprises at least one hydrophobically-modified (e.g., hydrophobic) smectite clay, an oil and/or wax, and a solvent comprising a volatile solvent.

According to a first aspect of the invention, therefore, there is provided a novel thixotropic composition comprising at least one smectite clay, a compatibilizing agent for hydrophobically-modifying the smectite clay, an oil and/or wax, and a solvent comprising a volatile solvent. In some embodiments, the compatibilizing agent is an edible compatibilizing agent. In some embodiments, the oil and/or wax is a natural oil or wax. In some embodiments, the solvent comprises water and a volatile solvent such as ethanol.

According to a second aspect of the invention, there is provided a novel thixotropic composition comprising at least one hydrophobically-modified (e.g., hydrophobic) smectite clay, an oil and/or wax, and a solvent comprising a volatile solvent. In some embodiments, the oil and/or wax is a natural oil or wax. In some embodiments, the thixotropic composition is edible. In some embodiments, the solvent comprises water and a volatile solvent.

As described herein, when applied to a hydrophobic surface, the thixotropic compositions of the invention form a hydrophobic coating on the surface, which is transparent and acts as a gas barrier. Accordingly, a thixotropic composition of the invention is useful for forming a transparent, hydrophobic, gas barrier coating on a hydrophobic surface. The coating is suitable for protecting an agricultural product from dehydration and/or oxidation; for improving shelf-life of an agricultural product; and for reducing or preventing oxygen ingress and/or water loss through a packaging material. Agricultural products include cut flowers or food products, such as produce (e.g., fruits and vegetables), and packaged agricultural products, such as packaged produce. These products have a hydrophobic surface.

The invention also provides methods of making a thixotropic composition of the invention, and thixotropic compositions made by the methods of the invention. The methods generally comprise mixing the smectite clay, the compatibilizing agent, the oil and/or wax, and the solvent comprising a volatile solvent. At least one step of the mixing process is performed under high shear mixing conditions; that is to say, at least two components of the composition are mixed together under high shear. In some aspects of the invention, all components of the composition are mixed together under high shear.

Therefore, according to a third aspect of the invention, there is provided a method of making a thixotropic composition, comprising mixing a smectite clay, a compatibilizing agent, an oil and/or wax, and a solvent comprising a volatile solvent under high shear. In some embodiments, the method further comprises applying said thixotropic composition to a hydrophobic surface of an agricultural product or to a packaging material.

According to a fourth aspect of the invention, there is provided a method of making a thixotropic composition, comprising dispersing at least one smectite clay in water, mixing a compatibilizing agent into the smectite clay in water under high shear to hydrophobically-modify the smectite clay and thereby form a hydrophobically-modified (e.g., hydrophobic) smectite clay, filtering, drying, and grinding the hydrophobically modified (e.g., hydrophobic) smectite clay to form a powder; mixing the powder under high shear with oil and/or wax; and adding a solvent comprising a volatile solvent. In some embodiments, the solvent comprises water and a volatile solvent such as ethanol. In some embodiments, the powdered hydrophobically-modified smectite clay is sieved before it is mixed with oil and/or wax. In some embodiments, the method further comprises applying said thixotropic composition to a hydrophobic surface of an agricultural product or to a packaging material.

According to a fifth aspect of the invention, there is provided a method of making a thixotropic composition, comprising wetting a smectite clay with water, adding a compatibilizing agent to the wetted smectite clay in a kneading machine equipped with an extruder head to hydrophobically-modify the smectite clay thereby forming a hydrophobically-modified (e.g., hydrophobic) smectite clay, extruding the hydrophobically-modified (e.g., hydrophobic) smectite clay through the extruder head to form ‘noodles’ or pellets (for example, the clay may be extruded as ‘noodles’, which are subsequently broken or divided into pellets); drying and grinding the pellets to form a powder; mixing the powder under high shear with oil and/or wax; and adding a solvent comprising a volatile solvent. In some embodiments, the solvent comprises water and a volatile solvent such as ethanol. In some embodiments, the powdered hydrophobically-modified smectite clay is sieved before it is mixed with oil and/or wax. In some embodiments, the method further comprises applying said thixotropic composition to a hydrophobic surface of an agricultural product or to a packaging material.

The invention also provides methods of applying a thixotropic composition of the invention to a hydrophobic surface of an agricultural product or a packaging material. Applying a thixotropic composition of the invention to such hydrophobic properties confers one or more advantageous properties, as described herein. For example, thixotropic compositions of the invention are useful in methods for protecting an agricultural product from dehydration and/or oxidation; or for improving the shelf-life of an agricultural product. Thixotropic compositions of the invention are useful in methods for protecting a packaging material from oxygen ingress and/or water loss through the packaging material, such as a packaging material used to package agricultural products. In general, these methods involve applying a thixotropic composition of the invention to a hydrophobic surface of the agricultural product and/or the packaging material, as required.

According to a sixth aspect of the invention, therefore, there is provided a method of protecting an agricultural product from dehydration and/or oxidation, comprising applying a thixotropic composition of the invention to a hydrophobic surface of the agricultural product. Agricultural products include cut flowers or food products, such as produce (e.g., fruits and vegetables), and packaged agricultural products, such as packaged produce. These products have a hydrophobic surface. In one embodiment, the thixotropic composition used in the method comprises at least one smectite clay, a compatibilizing agent (such as an edible compatibilizing agent) for hydrophobically-modifying the smectite clay, an oil and/or wax (such as a natural oil or wax), and a solvent comprising a volatile solvent. In another embodiment, the thixotropic composition used in the method comprises a hydrophobically-modified (e.g., hydrophobic) smectite clay, an oil and/or wax (such as a natural oil or wax), and a solvent comprising a volatile solvent. In some embodiments, the thixotropic composition is applied to the agricultural product via a dip tank, spray bar, or brush bed, or a combination thereof.

According to a seventh aspect of the invention, there is provided a method of improving the shelf-life of an agricultural product having a hydrophobic surface, comprising applying a thixotropic composition of the invention to a hydrophobic surface of the agricultural product. Agricultural products include cut flowers or food products, such as produce (e.g., fruits and vegetables), and packaged agricultural products, such as packaged produce. These products have a hydrophobic surface. In one embodiment, the thixotropic composition used in the method comprises at least one smectite clay, a compatibilizing agent (such as an edible compatibilizing agent) for hydrophobically-modifying the smectite clay, an oil and/or wax (such as a natural oil or wax), and a solvent comprising a volatile solvent. In another embodiment, the thixotropic composition used in the method comprises a hydrophobically-modified (e.g., hydrophobic) smectite clay, an oil and/or wax (such as a natural oil or wax), and a solvent comprising a volatile solvent. In some embodiments, the thixotropic composition is applied to the agricultural product via a dip tank, spray bar, or brush bed, or a combination thereof.

According to an eighth aspect of the invention, there is provided a method of protecting a packaging material from (e.g., reducing or even preventing) oxygen ingress and/or water loss through the packaging material, comprising applying a thixotropic composition of the invention to a hydrophobic surface of the packaging material. In one embodiment, the thixotropic composition used in the method comprises at least one smectite clay, a compatibilizing agent (such as an edible compatibilizing agent) for hydrophobically-modifying the smectite clay, an oil and/or wax (such as a natural oil or wax), and a solvent comprising a volatile solvent. In another embodiment, the thixotropic composition used in the method comprises a hydrophobically-modified (e.g., hydrophobic) smectite clay, an oil and/or wax (such as a natural oil or wax), and a solvent comprising a volatile solvent. In some embodiments, the thixotropic composition is applied to the packaging material via a dip tank, spray bar, or brush bed, or a combination thereof.

According to a ninth aspect of the invention, there is provided a method of protecting an agricultural product from dehydration and/or oxidation, or for improving the shelf-life of an agricultural product, comprising applying a thixotropic composition of the invention to a hydrophobic surface of a packaging material intended for packaging the agricultural product. For example, the packaging material may be for packaging a food product, typically produce. In one embodiment, the thixotropic composition used in the method comprises at least one smectite clay, a compatibilizing agent (such as an edible compatibilizing agent) for hydrophobically-modifying the smectite clay, an oil and/or wax (such as a natural oil or wax), and a solvent comprising a volatile solvent. In another embodiment, the thixotropic composition used in the method comprises a hydrophobically-modified (e.g., hydrophobic) smectite clay, an oil and/or wax (such as a natural oil or wax), and a solvent comprising a volatile solvent. In some embodiments, the thixotropic composition is applied to the packaging material via a dip tank, spray bar, or brush bed, or a combination thereof. After the composition has been applied to the packaging material, the method optionally further comprises using the packaging material to package an agricultural product.

According to a tenth aspect of the invention, there is provided a method of protecting an agricultural product from dehydration and/or oxidation, or for improving the shelf-life of an agricultural product, comprising applying a thixotropic composition of the invention to a hydrophobic surface of a packaging material enclosing the agricultural product. For example, the packaging material may be packaged around a food product, typically produce. In one embodiment, the thixotropic composition used in the method comprises at least one smectite clay, a compatibilizing agent (such as an edible compatibilizing agent) for hydrophobically-modifying the smectite clay, an oil and/or wax (such as a natural oil or wax), and a solvent comprising a volatile solvent. In another embodiment, the thixotropic composition used in the method comprises a hydrophobically-modified (e.g., hydrophobic) smectite clay, an oil and/or wax (such as a natural oil or wax), and a solvent comprising a volatile solvent. In some embodiments, the thixotropic composition is applied to the packaging material via a dip tank, spray bar, or brush bed, or a combination thereof.

According to an eleventh aspect of the invention, there is provided a method of applying a thixotropic composition to a hydrophobic surface of an agricultural product or its packaging material, comprising making a thixotropic composition of the invention, optionally by any of the methods of the invention described herein; and applying said thixotropic composition to the surface of an agricultural product or its packaging material via a dip tank, spray bar, or brush bed, or any combination thereof. Agricultural products include cut flowers or food products, such as produce (e.g., fruits and vegetables), and packaged agricultural products, such as packaged produce. These products have a hydrophobic surface. In one embodiment, the thixotropic composition used in the method comprises at least one smectite clay, a compatibilizing agent (such as an edible compatibilizing agent) for hydrophobically-modifying the smectite clay, an oil and/or wax (such as a natural oil or wax), and a solvent comprising a volatile solvent. In another embodiment, the thixotropic composition used in the method comprises a hydrophobically-modified (e.g., hydrophobic) smectite clay, an oil and/or wax (such as a natural oil or wax), and a solvent comprising a volatile solvent. In some embodiments, the thixotropic composition is made by any of the methods of the invention described herein and then applied to the agricultural product using a dip tank, spray bar, or brush bed, or a combination thereof.

A twelfth aspect of the present invention provides uses of a thixotropic composition of the invention. The invention provides the use of a thixotropic composition of the invention for protecting an agricultural product having a hydrophobic surface from dehydration and/or oxidation (e.g., for reducing or even preventing dehydration and/or oxidation of the agricultural product). The invention also provides the use of the thixotropic composition of the invention for improving the shelf-life of an agricultural product having a hydrophobic surface; optionally wherein the improvement is achieved relative to the shelf-life of the same agricultural product without the use of thixotropic composition of the invention, or relative to the shelf-life of the same agricultural product coated with a conventional composition known in the art. In these uses of the invention, the agricultural product is optionally produce, such as fruit or vegetable produce, or cut flowers. The invention further provides the use of a thixotropic composition of the invention for protecting a packaging material from oxygen ingress and/or water loss through the packaging material (e.g., for reducing or even preventing oxygen ingress and/or water loss through the packaging material). In any of these uses of the invention, the thixotropic composition may comprise at least one smectite clay, a compatibilizing agent (such as an edible compatibilizing agent) for hydrophobically-modifying the smectite clay, an oil and/or wax (such as a natural oil or wax), and a solvent comprising a volatile solvent. Alternatively, the thixotropic composition used may comprise a hydrophobically-modified (e.g., hydrophobic) smectite clay, an oil and/or wax (such as a natural oil or wax), and a solvent comprising a volatile solvent.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

Hydrophobic surfaces are susceptible to oxidation and loss of water and, thus, coatings are often applied to agricultural products in order to improve shelf life. The presently disclosed invention solves the problems of hydrophobic materials that require protection from dehydration and/or oxidation in addition to egress or ingress of water and allows consumers to view the coated products before purchase. For coating organic produce, such as organic fruit, in order to maintain the organic status of the produce, there is a further need for a composition that is not only edible but organic.

In a first aspect, the invention provides a thixotropic composition comprising at least one smectite clay, a compatibilizing agent (such as an edible compatibilizing agent) for hydrophobically-modifying the smectite clay, an oil and/or wax (such as a natural oil or wax), and a solvent comprising a volatile solvent.

When applied to a hydrophobic surface, the thixotropic composition forms a transparent hydrophobic gas barrier coating. For example, when applied to a hydrophobic surface of an agricultural product (e.g., food products, such as produce, which includes fruit and vegetables; or cut flowers), the thixotropic composition is effective for protecting the agricultural product from dehydration and/or oxidation, and/or for improving the shelf-life of the agricultural product. When applied to a hydrophobic surface of a packaging material, the thixotropic composition is effective for protecting the packaging material from oxygen ingress and/or water loss through the packaging material. If the packaging material packages, or is intended for packaging, an agricultural product, the protection from oxygen ingress and/or water loss through the packaging material that is conferred by the thixotropic composition of the invention is useful for protecting the agricultural product from dehydration and/or oxidation, and/or for improving the shelf-life of the agricultural product.

The term “thixotropic”, as used herein, refers to mixtures having non-Newtonian fluid dynamics whose flow properties, such as apparent viscosity, change with shear rate and duration of shear.

In some embodiments, the smectite clay is montmorillonite, Laponite (lithium sodium magnesium silicate, Na_{0.7}Si₈Mg_{5.5}Li_{0.3}O₂₀(OH)₄), bentonite, hectorite, or saponite, or a mixture of any two thereof, any three thereof, any four thereof, or all five thereof. In some embodiments, the smectite clay is selected from sodium montmorillonite, sodium bentonite, sodium hectorite, Laponite, or saponite, or a mixture of any two, three, four, or all five thereof. For example, the smectite clay may be sodium montmorillonite or Laponite.

In some embodiments, the thixotropic composition comprises smectite clay in an amount from 1.0 to 10.0 wt. % (percentage of the total weight of the thixotropic composition). In some embodiments, the thixotropic composition comprises smectite clay in an amount from 1.0 to 5.0 wt. %, from 1.0 to 3.0 wt. %, from 1.5 to 3.0 wt. %, or from 1.5 to 2.5 wt. % (percentage of the total weight of the thixotropic composition). In some embodiments, the thixotropic composition comprises smectite clay at (or at about) 1.5 wt. %, 2.0 wt. %, or 2.5 wt. % (percentage of the total weight of the thixotropic composition). In some embodiments, the thixotropic composition comprises sodium montmorillonite or Laponite in an amount from 1.0 to 10.0 wt. % (percentage of the total weight of the thixotropic composition). In some embodiments, the thixotropic composition comprises sodium montmorillonite in an amount from 1.0 to 5.0 wt. %, from 1.0 to 3.0 wt. %, from 1.5 to 3.0 wt. %, or from 1.5 to 2.5 wt. % (percentage of the total weight of the thixotropic composition). In some embodiments, the thixotropic composition comprises sodium montmorillonite at (or at about) 1.5 wt. %, 2.0 wt. %, or 2.5 wt. % (percentage of the total weight of the thixotropic composition). In some embodiments, the thixotropic composition comprises Laponite in an amount from 1.0 to 5.0 wt. %, from 1.0 to 3.0 wt. %, from 1.5 to 3.0 wt. %, or from 1.5 to 2.5 wt. % (percentage of the total weight of the thixotropic composition). In some embodiments, the thixotropic composition comprises Laponite at (or at about) 1.5 wt. %, 2.0 wt. %, or 2.5 wt. % (percentage of the total weight of the thixotropic composition).

The surface of (unmodified) smectite clay is partly or even substantially hydrophilic. Due to their hydrophilic nature, unmodified smectite clays do not disperse well within oil or wax and thus, the preparation of a composition comprising a smectite clay and an oil or wax is challenging. Therefore, a compatibilizing agent is included in the mixture to hydrophobically-modify the smectite clay in the composition. In general, a “compatibilizing agent” is an organic modifier that reacts with a substance and hydrophobically-modifies the substance. In particular, the term “compatibilizing agent”, as used herein, refers to an agent that hydrophobically-modifies (“hydrophobes”) the smectite clay in the composition, thereby rendering the smectite clay “hydrophobically-modified”. Compatibilizing agents react with smectite clay to hydrophobically modify the smectite clay particles and thereby make the clay compatible with hydrophobic polymers. Specifically, compatibilizing agents react with the smectite clay by bonding to exchangeable sodium ions on the surface of the clay via ion-dipole bonding of the OH groups, thereby converting the smectite clay surface from hydrophilic to hydrophobic. Hydrophobically-modified smectite clay (e.g., hydrophobic smectite clay) has the advantageous feature of being oil or wax loving, as opposed to water loving. The surface of a hydrophobically-modified smectite clay is substantially hydrophobic, and may be entirely hydrophobic. Accordingly, in some embodiments, a compatibilizing agent converts the smectite clay to a “hydrophobic smectite clay”.

Commonly-used compatibilizing agents include ionic liquids. Ionic liquids may be comprised of a combination of organic cations, including: ammonium, phosphonium, sulfonium, imidazolium, pyrrolidinium, piperidinium and/or pyridinium, with several organic and inorganic anions. Compatibilizing agents useful in the invention include sodium citrate, mono-or di-glycerides of a natural fats, and/or mono-or di-esters of pentaerythritol. Therefore, in some embodiments, the thixotropic composition of the invention comprises sodium citrate as the compatibilizing agent. In some embodiments, the compatibilizing agent in the thixotropic composition of the invention comprises a mono-or di-glyceride of a natural fat and/or a mono-or di-ester of pentaerythritol, such as an octadecyl monoester of pentaerythritol. In some embodiments, the thixotropic composition comprises montmorillonite and sodium citrate, such as sodium montmorillonite and sodium citrate. In some embodiments, the thixotropic composition comprises Laponite and sodium citrate. In further embodiments, the thixotropic composition comprises montmorillonite (e.g., sodium montmorillonite) and an octadecyl monoester of pentaerythritol.

In some embodiments, the thixotropic composition comprises a compatibilizing agent from 0.1 to 5.0 wt. % (percentage of the total weight of the thixotropic composition), such as from 0.1 to 2.0 wt. %, 0.1 to 1.0 wt. %, 0.1 to 0.5 wt. %, or 0.1 to 0.25 wt. %. Therefore, the thixotropic composition may comprise sodium citrate, a mono-or di-glyceride of a natural fat, and/or a mono-or di-ester of pentaerythritol (e.g., an octadecyl monoester of pentaerythritol) in an amount totaling from 0.1 to 5.0 wt. % (percentage of the total weight of the thixotropic composition) such as from 0.1 to 2.0 wt. %, 0.1 to 1.0 wt. %, 0.1 to 0.5 wt. %, or 0.1 to 0.25 wt. %. In some embodiments, the thixotropic composition comprises sodium citrate in an amount from 0.1 to 5.0 wt. % (percentage of the total weight of the thixotropic composition) such as from 0.1 to 2.0 wt. %, 0.1 to 1.0 wt. %, 0.1 to 0.5 wt. %, or 0.1 to 0.25 wt. %. In some embodiments, the thixotropic composition comprises montmorillonite (e.g., sodium montmorillonite) at 2-6 wt. %, and sodium citrate from 0.5 to 5.0 wt. % (percentage of the total weight of the thixotropic composition) such as from 0.1 to 2.0 wt. %, 0.1 to 1.0 wt. %, 0.1 to 0.5 wt. %, or 0.1 to 0.25 wt. %. In some embodiments, the thixotropic composition comprises Laponite at 2-6 wt. %, and sodium citrate from 0.5 to 5.0 wt. % (percentage of the total weight of the thixotropic composition) such as from 0.1 to 2.0 wt. %, 0.1 to 1.0 wt. %, 0.1 to 0.5 wt. %, or 0.1 to 0.25 wt. %.

In some embodiments, the compatibilizing agent is present in the composition at the milliequivalent value of the cation exchange capacity of the smectite clay. Cation exchange capacity may be measured indirectly with a methylene blue test or an ammonium exchange and Kjeldahl nitrogen determination. These methods are known in the art. The typical cation exchange capacity of a smectite clay is between 90 to 100 milliequivalents/100 grams.

The present invention further provides a novel thixotropic composition comprising at least one smectite clay, sodium citrate, an oil and/or wax, and a solvent comprising a volatile solvent. In some embodiments, the novel thixotropic composition comprises montmorillonite or Laponite, sodium citrate, an oil and/or wax, and a solvent comprising a volatile solvent.

The thixotropic compositions of the invention comprise an oil, a wax, or an oil and a wax. In some embodiments, the oil and/or wax is a natural oil or wax. The term “natural” or “naturally-occurring”, in this context, refers to an oil or wax that occurs in nature, or is derived from nature, and is not made or caused by humankind. This term does not require the oil or wax to be “obtained directly from nature”. A “natural” or “naturally-occurring” oil or wax may be nature-identical but this is not essential. The oil or wax is typically edible, meaning that the oil or wax is safe for human or animal consumption. In some embodiments, the oil and/or wax in the thixotropic composition is derived from a plant. In some embodiments, the thixotropic composition comprises a vegetable or nut oil. Examples of suitable oils for inclusion in the composition of the invention include canola oil, coconut oil, olive oil, and/or palm oil. In some embodiments, the thixotropic composition comprises canola oil or coconut oil. In some embodiments, the thixotropic composition alternatively, or additionally, comprises a wax. Examples of suitable waxes for inclusion in the composition of the invention include beeswax, candelilla wax, and/or carnauba wax.

In some embodiments, the thixotropic composition comprises an oil and/or wax between 1-10 wt. % (percentage of the total weight of the thixotropic composition). In some embodiments, the thixotropic composition comprises the oil and/or wax in an amount from 1.0 to 5.0 wt. %, from 1.0 to 3.0 wt. %, from 1.5 to 3.0 wt. %, or from 1.5 to 2.5 wt. % (percentage of the total weight of the thixotropic composition). In some embodiments, the thixotropic composition comprises the oil and/or wax at (or at about) 1.5 wt. %, 2.0 wt. %, or 2.5 wt. % (percentage of the total weight of the thixotropic composition).

In some embodiments, the weight ratio of oil and/or wax to smectite clay in the thixotropic composition is about 1:1.

The thixotropic compositions of the invention further comprise a solvent, wherein the solvent comprises or consists of a volatile solvent. The term “volatile”, as used herein, refers to liquids that easily vaporize into a gas. In some embodiments, the volatile solvent is ethanol. In other embodiments, the solvent comprises a mixture of a volatile solvent and water, for example, a mixture of ethanol and water. In some embodiments, the mixture comprises from 10-50% volatile solvent and from 50-90% water. In some embodiments, the mixture comprises 25 vol % volatile solvent and 75 vol % water. A mixture of 25 vol % volatile solvent and 75 vol % water is advantageous because it facilitates mixing of smectite clay and an oil or wax.

In some embodiments, the solvent is present in an amount of at least 85 wt. % (percentage of the total weight of the thixotropic composition). In some embodiments, the solvent is present at between 85 to 97.5 wt. %, such as between 90 to 97.5 wt. %. In some embodiments, the solvent is present at between 90 to 95 wt. % (percentage of the total weight of the thixotropic composition).

In some embodiments, the thixotropic composition is edible. The term “edible”, as used herein, refers to an item that is safe for human or animal consumption.

In some embodiments, the thixotropic composition is organic. The term “organic”, as used herein, refers to components that, once applied to produce, would not change the organic status of produce. Thus, these components meet the standards set for organically produced agricultural products, such as the regulations for an “organic” claim set by the national organic program (NOP) of the U.S. Department of Agriculture (USDA). In some embodiments, an organic composition does not contain any inorganic components, where the term “inorganic”, as used herein, refers to components that, once applied to produce, would change the organic status of produce.

The thixotropic compositions of the invention form a transparent coating on hydrophobic surfaces such as a surface of an agricultural product or a packaging material enclosing the product. The term “transparent”, as used herein, refers to a coating that allows light to pass through. As such, the coating film on the surface may be undetected by the human eye, or it may have a slightly “shiny” surface that differentiates it from an uncoated product. Therefore, the transparent coating allows the agricultural product to be distinctly seen (e.g., through the coating on its surface, and/or through the coated packaging material). It is known in the art to use thick coatings of compositions comprising cross-linked bentonite clays as UV protectants, which are at best translucent or opaque. The skilled person can test whether a coating on the surface of a product is transparent by eye or using methods known in the prior art.

The thixotropic compositions of the invention form a hydrophobic gas barrier coating on hydrophobic surfaces such as a surface of an agricultural product or a packaging material enclosing the product. A hydrophobic gas barrier, as used herein, refers to a coating that repels water and acts as a barrier to prevent movement of gas through the hydrophobic surface. Thereby, a hydrophobic gas barrier coating protects the surface to which it is applied from ingress of water and/or exchange of gas including oxygen through the surface. Accordingly, when applied to the surface of an agricultural product (e.g., produce) a hydrophobic gas barrier coating is useful for protecting against dehydration and/or oxidation of the product. When applied to the hydrophobic surface of packaging material, a hydrophobic gas barrier coating is useful for protecting against dehydration and/or oxidation of the product enclosed, or intended to be enclosed, within the packaging material.

In a second aspect, the invention provides a thixotropic composition comprising at least one hydrophobically-modified (e.g., hydrophobic) smectite clay, an oil and/or wax (such as a natural oil or wax), and a solvent comprising a volatile solvent. In some embodiments, the thixotropic composition comprises at least one hydrophobically-modified (e.g., hydrophobic) smectite clay, an oil and/or wax, and a solvent comprising water and a volatile solvent such as ethanol.

The description and definitions provided herein in the context of the thixotropic composition of the first aspect of the invention also apply to thixotropic composition of the second aspect of the invention, and to all other aspects of the invention, including each of the methods and uses of the invention described herein.

A “hydrophobically-modified smectite clay”, as used herein, refers to a smectite clay that has been hydrophobically-modified (“hydrophobed”). The surface of a hydrophobically-modified smectite clay is substantially hydrophobic, and may be entirely hydrophobic. Accordingly, in some embodiments, a “hydrophobically-modified smectite clay” may be referred to as a “hydrophobic smectite clay”. Hydrophobically-modified smectite clay (e.g., hydrophobic smectite clay) has the advantageous feature of being oil or wax loving, as opposed to water loving. A known method of determining whether a smectite clay is hydrophobic or hydrophilic is to use a contact angle measurement. Using standard contact angle measurement equipment known in the art, the contact angle of water droplets on smectite clay is measured. Water droplets form on hydrophobic surfaces, indicating that the cohesive forces associated within the droplet are greater than the forces associated with the interaction of water with the smectite clay surface. A contact angle greater than 90° between the surface of the smectite clay and the water droplet indicates that the clay is hydrophobic.

In some embodiments, the at least one hydrophobically-modified smectite clay is selected from hydrophobically-modified (e.g., hydrophobic) montmorillonite, Laponite (lithium sodium magnesium silicate, Na_{0.7}Si₈Mg_{5.5}Li_{0.3}O₂₀(OH)₄), bentonite, hectorite, or saponite, or a mixture of any two thereof, any three thereof, any four thereof, or all five thereof. In some embodiments, the hydrophobically-modified (e.g., hydrophobic) smectite clay is selected from hydrophobically-modified (e.g., hydrophobic) sodium montmorillonite, sodium bentonite, sodium hectorite, Laponite (Na_{0.7}Si₈Mg_{5.5}Li_{0.3}O₂₀(OH)₄) or saponite, or a mixture of any two, three, four, or all five thereof. For example, the composition may comprise hydrophobically-modified sodium montmorillonite or hydrophobically-modified Laponite.

In some embodiments, the thixotropic composition comprises hydrophobically-modified (e.g., hydrophobic) smectite clay in an amount from 1.0 to 10.0 wt. % (percentage of the total weight of the thixotropic composition). In some embodiments, the thixotropic composition comprises hydrophobically-modified (e.g., hydrophobic) smectite clay in an amount from 1.0 to 5.0 wt. %, from 1.0 to 3.0 wt. %, from 1.5 to 3.0 wt. %, or from 1.5 to 2.5 wt. % (percentage of the total weight of the thixotropic composition). In some embodiments, the thixotropic composition comprises hydrophobically-modified (e.g., hydrophobic) smectite clay at (or at about) 1.5 wt. %, 2.0 wt. %, or 2.5 wt. % (percentage of the total weight of the thixotropic composition).

In some embodiments, the oil and/or wax in the thixotropic composition is an edible and/or natural oil or wax, as defined herein. In some embodiments, the thixotropic composition comprises an oil or wax between 1-10 wt. % (percentage of the total weight of the thixotropic composition). In some embodiments, the thixotropic composition comprises the oil and/or wax in an amount from 1.0 to 5.0 wt. %, from 1.0 to 3.0 wt. %, from 1.5 to 3.0 wt. %, or from 1.5 to 2.5 wt. % (percentage of the total weight of the thixotropic composition). In some embodiments, the thixotropic composition comprises the oil and/or wax at (or at about) 1.5 wt. %, 2.0 wt. %, or 2.5 wt. % (percentage of the total weight of the thixotropic composition).

In some embodiments, the ratio of oil or wax to hydrophobically-modified (e.g., hydrophobic) smectite clay in the thixotropic composition is 1:1.

In some embodiments, the solvent consists of a volatile solvent, such as ethanol. In other embodiments, the solvent comprises a mixture of a volatile solvent, such as ethanol, and water. In some embodiments, the mixture comprises from 10-50% volatile solvent and from 50-90% water. In some embodiments, the mixture comprises 25 vol % volatile solvent and 75 vol % water, which advantageously facilitates mixing of smectite clay and an oil or wax. In some embodiments, the volatile solvent is ethanol. In some embodiments, the solvent is present in an amount of at least 85 wt. % (percentage of the total weight of the thixotropic composition), such as between 85 to 97.5 wt. %, or between 90 to 97.5 wt. %; optionally between 90 to 95 wt. % (percentage of the total weight of the thixotropic composition).

In some embodiments, the thixotropic composition is edible, which has the meaning defined herein. In some embodiments, the composition is organic, which has the meaning defined herein.

The thixotropic composition forms a coating on hydrophobic surfaces such as a surface of an agricultural product or a packaging material enclosing the product, which is transparent, and acts as a hydrophobic gas barrier. These terms are defined herein.

In some embodiments of any of the thixotropic compositions described herein, the thixotropic composition of the invention does not contain PVOH. For example, in some embodiments, the thixotropic composition of the invention does not contain any synthetic polymer and/or does not contain any semi-synthetic polymer.

The invention also provides methods for making a thixotropic composition, and compositions made by these methods. The description and definitions provided herein in the context of the thixotropic composition of the first and second aspect of the invention also apply to methods for making a thixotropic composition of the invention.

The methods of the invention for making a thixotropic composition involve at least one step performed under high shear. Any of the methods or method steps described herein that involve high shear mixing may be carried out using any known high shear mixer, such as a vane mixer, Cowles dissolver, or colloid mill. High shear mixing requires equipment with high RPM and horsepower that ensure the dispersion blade can reach top speeds of between 2,500 to 5,000 feet per minute. The high shear mixing process may take 1-2 hours. For mixing of smaller batches of composition, a high shear blender may be used. High shear forces may also be applied by extrusion, as described herein. High shear mixing methods are advantageous because they achieve rapid mixing of the smectite clay and solvent (and other components, if present) to form a thixotropic mixture, such as a dispersion with an even dispersal of smectite clay particles (platelets). When using standard mixing methods that do not involve high shear (such as a tank with paddle mixer), mixing of smectite clay and solvent will never fully disperse the smectite clay to form an evenly dispersed mixture. This is because the smectite clay platelets are held together in stacks by many weak bonds, such as hydrogen bonds and ion dipole interactions, which collectively amount to a large cohesive force. Standard mixing is not sufficient to overcome this cohesive energy. When using a method that involves high shear, the increased energy and substantial force imposed by the high shear is sufficient to break the forces that holds these smectite clay platelets together. Thus, a method of making the composition of the invention using high shear is highly efficient. High shear mixing reduces the viscosity of the thixotropic composition facilitating the mixing and reaction of the compatibilizing agent to convert the smectite clay from hydrophilic to hydrophobic. High shear mixing is also useful for incorporating oil and/or wax into the thixotropic mixture, as described herein.

In a third aspect, therefore, the invention provides a method of making a thixotropic composition comprising at least one smectite clay, a compatibilizing agent, an oil and/or wax, and a solvent comprising a volatile solvent. The method comprises mixing under high shear the smectite clay, the compatibilizing agent, the oil or wax, and the solvent. The at least one smectite clay used in the method can be any of the smectite clays described herein. Similarly, the compatibilizing agent, the oil and/or wax, and the solvent comprising a volatile solvent used in the method, can each be any of the compatibilizing agents, the oils and/or waxes, and the solvents as defined herein.

In some embodiments, the method comprises mixing under high shear montmorillonite or laponite, sodium citrate, a natural oil and/or wax, and a solvent comprising a volatile solvent such as ethanol. In some embodiments, the method comprises mixing under high shear montmorillonite (e.g., sodium montmorillonite), sodium citrate, a natural oil and/or wax, and a solvent comprising ethanol and optionally water. In other embodiments, the method comprises mixing under high shear Laponite, sodium citrate, a natural oil and/or wax, and a solvent comprising ethanol and optionally water. In any of these embodiments, the natural oil is optionally canola oil or coconut oil, and/or the natural wax is optionally beeswax, carnauba wax, or candelilla wax.

In a fourth aspect, the invention provides a method of making a thixotropic composition, comprising dispersing at least one smectite clay in water; and then mixing a compatibilizing agent into the smectite clay in water under high shear to hydrophobically-modify the smectite clay and thereby form a hydrophobically-modified (e.g., hydrophobic) smectite clay. The hydrophobically-modified (e.g., hydrophobic) smectite clay is then filtered, dried, and ground to a powder, before mixing the powder with oil and/or wax under high shear, and then adding a solvent comprising a volatile solvent. The at least one smectite clay used in the method can be any of the smectite clays described herein. Similarly, the compatibilizing agent, the oil and/or wax, and the solvent comprising a volatile solvent used in the method, can each be any of the compatibilizing agents, the oils and/or waxes, and the solvents as defined herein.

Methods of high shear mixing are described above. High shear mixing reduces the viscosity of the smectite clay and water dispersion, facilitating the mixing and reaction of the compatibilizing agent with the smectite clay to hydrophobically-modify the smectite clay and thereby form a hydrophobically-modified (e.g., hydrophobic) smectite clay (i.e., converts the smectite clay to a “hydrophobic smectite clay”), as described above. The dispersing and mixing steps of the method are performed using standard equipment known in the art, such as a blender, typically for small batches, or a Cowles blade or a vane mixer (vane type pump), typically for larger batches. This mixing process may be at 1500-2000 feet per minute. The smectite clay in water dispersion forms a thixotropic mixture, which has the meaning defined herein.

In some embodiments, the method comprises dispersing montmorillonite (e.g., sodium montmorillonite) in water. In some embodiments, the method comprises dispersing Laponite in water. In some embodiments, the smectite clay is dispersed in water at approximately 1.5-5.0 wt. % (percentage of the total weight of the thixotropic composition). In some embodiments, the smectite clay is dispersed in water at 1.0 to 3.0 wt. %, from 1.5 to 3.0 wt. %, or from 1.5 to 2.5 wt. % (percentage of the total weight of the thixotropic composition). In some embodiments, the thixotropic composition comprises smectite clay (e.g., montmorillonite or Laponite) at (or at about) 1.5 wt. %, 2.0 wt. %, or 2.5 wt. % (percentage of the total weight of the thixotropic composition).

The hydrophobically-modified (e.g., hydrophobic) smectite clay obtained in the high shear mixing step may be filtered using standard methods known in the art, such as using a commercially available basis-plate and frame filter press. The method then comprises drying the filtered clay using standard methods known in the art, such as by using an external heat source, such as using a drum dryer or a spray dryer. The method then comprises grinding the dried, filtered clay to a powder. Any standard grinding method known in the art may be used, such as using a hammer mill or ball mill.

The powdered hydrophobically-modified (e.g., hydrophobic) smectite clay is then mixed under high shear with oil and/or wax. Suitable high shear mixing methods are described above. In some embodiments, the oil and/or wax is mixed under high shear until a uniform exfoliated solution is reached. A uniform exfoliated solution is reached once the energy and substantial force imposed by the high shear reaches a level sufficient to break the large cohesive forces (due to many weak bonds, such as hydrogen bonds and ion dipole interactions) that stack the smectite clay platelets together.

In some embodiments, the powdered hydrophobically-modified (e.g., hydrophobic) smectite clay is sieved before it is mixed with oil and/or wax. For example, a sieve of less than 325 mesh can be used (i.e., the sieve has 325 openings/inch).

In a fifth aspect, the present invention provides a method of making a thixotropic composition comprising wetting smectite clay with water; adding a compatibilizing agent to the wetted smectite clay in a kneading machine equipped with an extruder head to hydrophobically-modify the smectite clay thereby forming a hydrophobically-modified (e.g., hydrophobic) smectite clay; and extruding the hydrophobically-modified (e.g., hydrophobic) smectite clay through the extruder head to form pellets. The hydrophobically-modified (e.g., hydrophobic) smectite clay pellets are then dried and ground to a powder. The powder is then mixed under high shear with oil and/or wax, before adding a solvent comprising a volatile solvent.

In some embodiments, the method comprises wetting montmorillonite (e.g., sodium montmorillonite) with water. In some embodiments, the method comprises wetting Laponite with water. In some embodiments, the wetting step results in a dough that is 30-90 wt. % smectite clay. In some embodiments, the wetted smectite clay dough is 80-90 wt. % smectite clay, such as 85 wt. % smectite clay.

A kneading machine, preferably a pugmill, is used to combine the compatibilizing agent with the wetted smectite clay dough to hydrophobically-modify the wetted smectite clay and thereby form a wetted, hydrophobically-modified (e.g., hydrophobic) smectite clay. The energy of the kneading process mixes and heats the water and smectite clay to form a thixotropic mixture with an even distribution of smectite clay particles (platelets). Once kneaded, the hydrophobically-modified wetted smectite clay dough is extruded through the extrusion head of the kneading machine to form pellets of hydrophobic smectite clay. The extrusion step imparts further high shear to the clay dough. An extrusion orifice of roughly 0.25 in is typically used.

The extruded pellets of hydrophobically-modified (e.g., hydrophobic) smectite clay may be dried and ground, and optionally sieved, using any of the known methods described above.

In some embodiments of any of the methods of making a thixotropic composition of the invention, the smectite clay is selected from montmorillonite, Laponite (Na_{0.7}Si₈Mg_{5.5}Li_{0.3}O₂₀(OH)₄), bentonite, hectorite, or saponite, or a mixture of any two thereof, any three thereof, any four thereof, or all five thereof. In some embodiments of any of the methods of making a thixotropic composition of the invention, the smectite clay is selected from sodium montmorillonite, sodium bentonite, sodium hectorite, Laponite or saponite, or a mixture of any two thereof, any three thereof, any four thereof, or all five thereof. For example, the smectite clay may comprise sodium montmorillonite or Laponite.

In some embodiments of any of the methods of making a thixotropic composition of the invention, the thixotropic composition made by the method comprises smectite clay in an amount from 1.0 to 10.0 wt. % (percentage of the total weight of the thixotropic composition). In some embodiments, the thixotropic composition comprises smectite clay in an amount from 1.0 to 5.0 wt. %, from 1.0 to 3.0 wt. %, from 1.5 to 3.0 wt. %, or from 1.5 to 2.5 wt. % (percentage of the total weight of the thixotropic composition). In some embodiments, the thixotropic composition comprises smectite clay at (or at about) 1.5 wt. %, 2.0 wt. %, or 2.5 wt. % (percentage of the total weight of the thixotropic composition).

The step of combining smectite clay with a compatibilizing agent hydrophobically-modifies the smectite clay. The term “compatibilizing agent”, has the meaning defined herein. In some embodiments of any of the methods of the invention for making a thixotropic composition, the compatibilizing agent is selected from sodium citrate. In other embodiments, the compatibilizing agent is a mono-or di-glyceride of a natural fat, and/or a mono-or di-ester of pentaerythritol, such as an octadecyl monoester of pentaerythritol. In some embodiments of any of the methods of making a thixotropic composition of the invention, the smectite clay is montmorillonite (e.g., sodium montmorillonite) and the compatibilizing agent is sodium citrate. In some embodiments of any of the methods of making a thixotropic composition of the invention, the smectite clay is Laponite and the compatibilizing agent is sodium citrate.

In some embodiments of any of the methods of making a thixotropic composition of the invention, the thixotropic composition made by the method comprises a compatibilizing agent from 0.5 to 5.0 wt. % (percentage of the total weight of the thixotropic composition), such as from 0.1 to 2.0 wt. %, 0.1 to 1.0 wt. %, 0.1 to 0.5 wt. %, or 0.1 to 0.25 wt. %. In some embodiments of any of the methods of making a thixotropic composition of the invention, the thixotropic composition comprises sodium citrate in an amount from 0.1 to 5.0 wt. % (percentage of the total weight of the thixotropic composition) such as from 0.1 to 2.0 wt. %, 0.1 to 1.0 wt. %, 0.1 to 0.5 wt. %, or 0.1 to 0.25 wt. %. In some embodiments of any of the methods of making a thixotropic composition of the invention, the thixotropic composition comprises montmorillonite (e.g., sodium montmorillonite) at 2-6 wt. %, and sodium citrate from 0.5 to 5.0 wt. % (percentage of the total weight of the thixotropic composition) such as from 0.1 to 2.0 wt. %, 0.1 to 1.0 wt. %, 0.1 to 0.5 wt. %, or 0.1 to 0.25 wt. %. In some embodiments of any of the methods of making a thixotropic composition of the invention, the thixotropic composition comprises Laponite at 2-6 wt. %, and sodium citrate from 0.5 to 5.0 wt. % (percentage of the total weight of the thixotropic composition) such as from 0.1 to 2.0 wt. %, 0.1 to 1.0 wt. %, 0.1 to 0.5 wt. %, or 0.1 to 0.25 wt. %.

In some embodiments of any of the methods of making a thixotropic composition of the invention, the oil and/or wax is an edible or natural oil or wax, as defined herein. In some embodiments of any of the methods of making a thixotropic composition of the invention, the thixotropic composition comprises an oil or wax between 1-10 wt. % (percentage of the total weight of the thixotropic composition). In some embodiments, the thixotropic composition comprises the oil and/or wax in an amount from 1.0 to 5.0 wt. %, from 1.0 to 3.0 wt. %, from 1.5 to 3.0 wt. %, or from 1.5 to 2.5 wt. % (percentage of the total weight of the thixotropic composition). In some embodiments, the thixotropic composition comprises the oil and/or wax at (or at about) 1.5 wt. %, 2.0 wt. %, or 2.5 wt. % (percentage of the total weight of the thixotropic composition).

In some embodiments of any of the methods of the invention for making a thixotropic composition, the oil and/or wax and the smectite clay are added at a ratio of 1:1 (wt/wt).

The methods of making a thixotropic composition of the invention employ a solvent comprising a volatile solvent, as defined herein. In some embodiments, the solvent consists of a volatile solvent, such as ethanol. In other embodiments, the solvent comprises a mixture of a volatile solvent, such as ethanol, and water. For example, the solvent mixture may comprise from 10-50 vol % volatile solvent and from 50-90 vol % water; such as about 25 vol % volatile solvent and 75 vol % water, which advantageously facilitates mixing of smectite clay and an oil or wax. In some embodiments, the solvent added to an amount of at least 85 wt. % (percentage of the total weight of the thixotropic composition), such as between 85 to 97.5 wt. %, or between 90 to 97.5 wt. %; optionally between 90 to 95 wt. %.

The invention also provides a thixotropic composition made by any of the methods of the invention. A thixotropic composition made by any of the methods of the invention may be edible, and may optionally be organic. These terms have the meanings defined herein.

In some embodiments of any of the methods of making a thixotropic composition of the invention, the method further comprises applying the thixotropic composition to a product a having a hydrophobic surface. In some embodiments of any of the methods of making a thixotropic composition of the invention, the composition is applied using a spray bar, dip tank, brush bed, ink jet printing, gravure, or doctor knife, or a combination thereof. For example, the composition made according to any of the methods of the invention may be applied using a combination of a spray bar and brush bed, or using a dip tank and brush bed. The method may further comprise drying the composition following application (e.g., by applying heat), but more typically the composition is left to dry naturally under ambient conditions. The thixotropic composition forms a coating on a hydrophobic surface to which it is applied. The coating is transparent, and acts as a hydrophobic gas barrier. These terms are defined herein.

Examples of products with at least one hydrophobic surface include an agricultural product. The term “agricultural product” as used herein in connection with all aspects of the invention, refers to a product that is derived from plants and animals. Agricultural products include cut flowers and plants, and also include food products, such as produce (e.g., fruits and vegetables). These products have a hydrophobic surface. In some embodiments, the agricultural product is produce. The term “produce”, as used herein, refers to a farm-produced crop. In some embodiments, the produce is fruit, such as pome fruits, citrus fruits, or tomatoes. The invention is particularly applicable to pome fruits, more particularly apples, pears, and/or quince. In other embodiments, the produce is vegetables. For example, the vegetable produce may be cucumbers or mushrooms. In further embodiments, the produce is cut flowers, such as roses. In some embodiments, the thixotropic composition is applied to an agricultural product pre-harvest, but in other embodiments the thixotropic composition is applied post-harvest.

Further examples of products with at least one hydrophobic surface include packaging materials. The term “packaging materials” as used herein in connection with all aspects of the invention includes bags, films and wraps including shrink-wrap or vacuum packaging, boxes, cartons, trays, and other containers. Packaging materials may be made of plastic, such as polypropylene (PP) or polyethylene (PE). In some embodiments, the thixotropic composition is applied to packaging material before it is used to package a product, but in other embodiments the thixotropic composition is applied to the packaging material after it has been used to package a product, that is once the product is enclosed within the packaging material.

The invention also provides methods in which a thixotropic composition of the invention is applied to a hydrophobic surface of an agricultural product or a packaging material, to provide one or more technical effects as described herein. The description and definitions provided herein in the context of the thixotropic composition of the first and second aspect of the invention, also apply to methods described below for protecting an agricultural product from dehydration and/or from oxidation, for improving shelf-life, and/or for protecting against oxygen ingress and/or water loss through a packaging material.

In a sixth aspect, therefore, the invention provides a method of protecting an agricultural product from dehydration and/or oxidation, comprising applying a thixotropic composition of the invention to a hydrophobic surface of the agricultural product. For example, the method is for protecting an agricultural product from dehydration and/or oxidation during storage, or whilst on display. An agricultural product is as defined herein. In one embodiment, the thixotropic composition used in the method comprises a hydrophobically-modified (e.g., hydrophobic) smectite clay, an oil and/or wax, and a solvent comprising a volatile solvent. In another embodiment, the thixotropic composition used in the method comprises at least one smectite clay, a compatibilizing agent for hydrophobically-modifying the smectite clay, an oil and/or wax, and a solvent comprising a volatile solvent. The terms “smectite clay”, “compatibilizing agent”, “hydrophobically-modified smectite clay”, “oil and/or wax”, and “solvent comprising a volatile solvent” are as defined herein. The thixotropic composition may be applied to the agricultural product pre-harvest, but is more typically applied post-harvest.

Dehydration of agricultural products is accelerated in drier environmental conditions and with exposure to air/oxygen. For example, water is lost from produce, such as fruit (e.g., pome fruit) and vegetables, during storage. The thixotropic compositions and related methods of the invention are useful for reducing moisture loss from a product by reducing the moisture vapor transmission rate across the hydrophobic surface of the product or its packaging material to which the thixotropic composition is applied. Protecting an agricultural product “from dehydration”, as used herein, refers to protecting against moisture loss (such as loss of water) from an agricultural product. In these embodiments, “protecting” from dehydration encompasses reducing or even preventing dehydration. A reduction in dehydration may be defined in comparison to the dehydration of the same product without any coating composition (uncoated control), or in comparison to the dehydration of the same product coated with a conventional composition known in the art. Methods are known in the art for observing and measuring dehydration of agricultural products. For example, dehydration may be measured by weighing the produce, where a loss of weight corresponds to loss of moisture. In some embodiments, an agricultural product coated in a thixotropic composition of the invention loses at least 5% less weight during storage for three weeks at ambient temperature, as compared to the same agricultural product that is uncoated (control). For example, an agricultural product coated in a thixotropic composition of the invention loses at least 10%, 20%. 25%, 30%, 40%, 45%, 50%, or 55% less weight during storage for three weeks at ambient temperature, as compared to the same agricultural product that is uncoated (control).

Oxidation of produce, such as fruits (e.g., pome fruit) and vegetables, causes browning and softening of the produce. The thixotropic compositions and related methods of the invention are useful for protecting a product from oxidation by reducing the oxygen transmission rate across a hydrophobic surface of the product or its packaging material to which the thixotropic composition is applied. Protecting an agricultural product “from oxidation”, as used herein, refers to protecting against oxidation of the surface of the agricultural product. In these embodiments, “protecting” from oxidation encompasses reducing or even preventing oxidation. A reduction in oxidation may be defined in comparison to the oxidation of the same product without any coating composition (uncoated control), or in comparison to the oxidation of the same product coated with a conventional composition known in the art. Methods are known in the art for observing and measuring oxidation of agricultural products. For example, oxidation of an agricultural product (e.g., browning and/or softening of produce such as fruit, especially pome fruit) is typically observed and measured by eye.

In a seventh aspect, the present invention provides a method of improving the shelf-life of an agricultural product having a hydrophobic surface, comprising applying a thixotropic composition of the invention to a hydrophobic surface of the agricultural product. Agricultural products are as defined herein. In one embodiment, the thixotropic composition used in the method comprises a hydrophobically-modified (e.g., hydrophobic) smectite clay, an oil and/or wax, and a solvent comprising a volatile solvent. In another embodiment, the thixotropic composition used in the method comprises at least one smectite clay, a compatibilizing agent for hydrophobically-modifying the smectite clay, an oil and/or wax, and a solvent comprising a volatile solvent. The terms “smectite clay”, “compatibilizing agent”, “hydrophobically-modified smectite clay”, “oil and/or wax”, and “solvent comprising a volatile solvent” are as defined herein. The thixotropic composition may be applied to the agricultural product pre-harvest, but is more typically applied post-harvest.

The shelf-life of an agricultural product, particularly fresh produce, may be defined as the length of time that the product may be stored without becoming unfit for use, consumption, or sale. During the shelf-life of a product, the defined quality of a specified proportion of the product remains acceptable under expected (or specified) conditions. Dehydration and/or oxidation of an agricultural product may reduce its shelf-life. Therefore, protecting the product against dehydration and/or oxidation is useful for maintaining the product's expected shelf-life or improving the product's shelf-life. An “improvement” in shelf-life may be an extension of the length of time that the product may be stored without becoming unfit for use, consumption, or sale. The improvement in shelf-life is achieved in comparison to the shelf-life of the same agricultural product without any coating composition uncoated control), or in comparison to the shelf-life of the same agricultural product coated with a conventional composition known in the art.

In an eighth aspect, the invention provides a method of protecting a packaging material from oxygen ingress and/or moisture loss (e.g., water loss) through a hydrophobic surface of the packaging material, comprising applying a thixotropic composition of the invention to the hydrophobic surface of the packaging material. In one embodiment, the thixotropic composition used in the method comprises a hydrophobically-modified (e.g., hydrophobic) smectite clay, an oil or wax, and a solvent comprising a volatile solvent. In another embodiment, the thixotropic composition used in the method comprises at least one smectite clay, a compatibilizing agent for hydrophobically-modifying the smectite clay, an oil or wax, and a solvent comprising a volatile solvent. The terms “smectite clay”, “compatibilizing agent”, “hydrophobically-modified smectite clay”, “oil and/or wax”, and “solvent comprising a volatile solvent” are as defined herein. After the thixotropic composition has been applied to the packaging material, the method optionally further comprises using the packaging material to package an agricultural product.

In some embodiments, the method provides protection from oxygen ingress. In other embodiments, the protection is from moisture loss, such as or including water loss. In further embodiments, the method provides protection from both oxygen ingress and moisture loss, such as or including water loss. The thixotropic compositions and related methods of the invention are useful for protecting a packaging material from oxygen ingress and/or moisture loss (e.g., water loss) through the packaging material by reducing the transmission rate of oxygen and/or moisture (e.g., water) vapor across the hydrophobic surface of the product or its packaging material to which the thixotropic composition is applied. In these embodiments, “protecting” a packaging material from oxygen ingress and/or moisture loss through the hydrophobic surface of the packaging material encompasses reducing or even preventing oxygen ingress and/or moisture loss (e.g., water loss). A reduction in oxygen ingress and/or moisture loss (e.g., water loss) may be defined in comparison to the oxygen ingress and/or moisture loss (e.g., water loss) through the same hydrophobic surface of a packaging material without any coating composition (uncoated control), or in comparison to the oxygen ingress and/or moisture loss (e.g., water loss) through the same hydrophobic surface of a packaging material coated with a conventional composition known in the art.

In a ninth aspect, the present invention provides a method of protecting an agricultural product from dehydration and/or oxidation, or for improving the shelf-life of an agricultural product, comprising applying a thixotropic composition of the invention to a hydrophobic surface of a packaging material intended for packaging the agricultural product. Suitable packaging materials are defined herein. An agricultural product is defined herein. Protection against dehydration and/or oxidation, and improving the shelf-life, are defined herein. In one embodiment, the thixotropic composition used in the method comprises a hydrophobically-modified (e.g., hydrophobic) smectite clay, an oil or wax, and a solvent comprising a volatile solvent. In another embodiment, the thixotropic composition used in the method comprises at least one smectite clay, a compatibilizing agent for hydrophobically-modifying the smectite clay, an oil or wax, and a solvent comprising a volatile solvent. The terms “smectite clay”, “compatibilizing agent”, “hydrophobically-modified smectite clay”, “oil and/or wax”, and “solvent comprising a volatile solvent” are as defined herein. After the thixotropic composition has been applied to the packaging material, the method optionally further comprises using the packaging material to package an agricultural product.

In a tenth aspect, the invention provides a method of protecting an agricultural product from dehydration and/or oxidation, or for improving the shelf-life of an agricultural product, comprising applying a thixotropic composition of the invention to a hydrophobic surface of a packaging material that encloses the agricultural product. For example, the packaging material may be packaged around a food product, typically produce. Suitable packaging materials are defined herein. An agricultural product is defined herein. Protection against dehydration and/or oxidation, and improving the shelf-life, are defined herein. In one embodiment, the thixotropic composition used in the method comprises a hydrophobically-modified (e.g., hydrophobic) smectite clay, an oil or wax, and a solvent comprising a volatile solvent. In another embodiment, the thixotropic composition used in the method comprises at least one smectite clay, a compatibilizing agent for hydrophobically-modifying the smectite clay, an oil or wax, and a solvent comprising a volatile solvent. The terms “smectite clay”, “compatibilizing agent”, “hydrophobically-modified smectite clay”, “oil and/or wax”, and “solvent comprising a volatile solvent” are as defined herein.

In any of these methods of the invention, in some embodiments, the thixotropic composition is applied to the hydrophobic surface using a dip tank, spray bar, or brush bed, or any combination thereof. For example, the composition is applied using a spray bar, optionally using a spray bar and brush bed.

In a twelfth aspect, the present invention provides uses of a thixotropic composition of the invention. The invention provides the use of a thixotropic composition of the invention for protecting an agricultural product having a hydrophobic surface from dehydration and/or oxidation (e.g., for reducing or even preventing dehydration and/or oxidation of the agricultural product). The invention also provides the use of the thixotropic composition of the invention for improving the shelf-life of an agricultural product having a hydrophobic surface; optionally wherein the improvement is achieved relative to the shelf-life of the same agricultural product without the use of thixotropic composition of the invention, or relative to the shelf-life of the same agricultural product coated with a conventional composition known in the art. In these uses of the invention, the agricultural product is optionally produce, such as fruit or vegetable produce (typically pome fruit), or cut flowers. The invention further provides the use of a thixotropic composition of the invention for protecting a packaging material from oxygen ingress and/or water loss through the packaging material (e.g., for reducing or even preventing oxygen ingress and/or water loss through the packaging material). In any of these uses of the invention, the thixotropic composition may comprise a hydrophobically-modified (e.g., hydrophobic) smectite clay, an oil or wax, and a solvent comprising a volatile solvent. Alternatively, the thixotropic composition used may comprise at least one smectite clay, a compatibilizing agent for hydrophobically-modifying the smectite clay, an oil or wax, and a solvent comprising a volatile solvent.

### EXAMPLE 1

A trial was conducted in which apples were coated with a thixotropic composition comprising 25 grams of Laponite, 16 grams of canola oil and 2 grams of sodium citrate per liter of solvent. The thixotropic composition was made by mixing the Laponite, canola oil, sodium citrate, and the solvent in a blender and sheared until it reached 80 degrees Celsius. The coating was applied by hand with a paint sprayer and was allowed to dry under ambient conditions. The weight of the apples was monitored for three weeks at ambient temperature. Compared to uncoated (control) apples, the apples coated in the thixotropic composition lost 8% less weight.

### EXAMPLE 2

A trial was conducted in which apples were coated with a thixotropic composition comprising 16 grams of Laponite, 25 grams of canola oil and 2 grams of sodium citrate per liter of solvent. The thixotropic composition was made by mixing the Laponite, canola oil, sodium citrate, and the solvent in a blender and sheared until it reached 80 degrees Celsius. The coating was applied by hand to the apples with a paint sprayer and was allowed to dry under ambient conditions. The weight of the apples was monitored for three weeks at ambient temperature. Compared to uncoated (control) apples, the apples coated in the thixotropic composition lost 25.4% less weight.

### EXAMPLE 3

A trial was conducted in which apples were coated with a thixotropic composition comprising 25 grams of montmorillonite, 15 grams of canola oil, 3.5 grams of beeswax and 2 grams of sodium citrate per liter of solvent. The thixotropic composition was made by mixing the montmorillonite, canola oil, beeswax, sodium citrate and the solvent in a blender and sheared until it reached 80 degrees Celsius. The coating was applied to the apples by hand with a paint sprayer and was allowed to dry under ambient conditions. The weight of the apples was monitored for three weeks at ambient temperature. Compared to uncoated (control) apples, the apples coated in the thixotropic composition lost 45.9% less weight.

### EXAMPLE 4

A trial was conducted in which apples were coated with a thixotropic composition comprising 20 grams of laponite, 25 grams of coconut oil and 2 grams of sodium citrate per liter of solvent. The thixotropic composition was made by mixing the Laponite, coconut oil, sodium citrate, and the solvent in a blender and sheared until it reached 80 degrees Celsius. The coating was applied to the apples by hand with a paint sprayer and was allowed to dry under ambient conditions. The weight of the apples was monitored for three weeks at ambient temperature. Compared to uncoated (control) apples, the apples coated in the thixotropic composition lost 31% less weight.

### EXAMPLE 5

An experiment was conducted in which Bartlett pears were coated with a thixotropic composition comprising 25 grams of sodium montmorillonite, 9.5 grams of octadecyl monoester of pentaerythritol, and 18 grams of candelilla wax per liter of 75 vol % water and 25 vol % ethanol. The thixotropic composition was made by mixing the sodium montmorillonite, octadecyl monoester of pentaerythritol, candelilla wax, water, and ethanol in a blender for 40 minutes. This thixotropic composition was utilized to coat the Bartlett pears with a hand sprayer and hand rubbing to simulate a spray bar and brush bed. The Bartlett pears were stored for 3 weeks, and the was dehydration measured. Compared to uncoated (control) pears, the pears coated in the thixotropic composition demonstrated 55% lower levels of dehydration.

### EXAMPLE 6

A further experiment was conducted in which Bartlett pears were coated with a thixotropic composition comprising 25 grams of sodium montmorillonite, 9.5 grams of octadecyl monoester of pentaerythritol, and 18 grams of candelilla wax per liter of 75 vol % water and 25 vol % ethyl alcohol. The thixotropic composition was made by wetting a mixture of powdered sodium montmorillonite and octadecyl monoester of pentaerythritol with 15 grams of water and ethanol, at 75 vol %: 25 vol %, to prepare a wetted hydrophobic smectite clay. The wetted hydrophobic smectite clay was placed in a pug mill and extruded. The extruded hydrophobic smectite clay pellets (noodles) were then dried and ground to form a powdered hydrophobic smectite clay, using a ball mill. The powdered hydrophobic smectite clay was then dispersed in a blender for 20 minutes in water and ethanol, at 75 vol %: 25 vol %, at a solids concentration of 5.25%. This thixotropic composition was utilized to coat bartlett pears with a hand sprayer and hand rubbing to simulate a spray bar and brush bed. The Bartlett pears were stored for 3 weeks in cold storage, and the dehydration was measured. Compared to uncoated (control) pears, the pears coated in the thixotropic composition demonstrated 49% lower levels of dehydration.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

1. A thixotropic composition for protecting an agricultural product from dehydration and/or oxidation, comprising:
(a) at least one smectite clay;
(b) a compatibilizing agent for hydrophobically-modifying the smectite clay;
(c) an oil and/or wax; and
(d) a solvent, comprising a volatile solvent.

2. The thixotropic composition of claim 1, wherein the at least one smectite clay is from 1 to 10 wt. %, optionally from 1 to 5 wt. %.

3. The thixotropic composition of claim 1 or claim 2, wherein the at least one smectite clay is montmorillonite, Laponite, bentonite, hectorite, or saponite; or a mixture of any two or more thereof.

4. The thixotropic composition of any one of claims 1-3, wherein the compatibilizing agent comprises or consists of sodium citrate; or wherein the compatibilizing agent comprises or consists of a mono-or di-glyceride of a natural fat and/or a mono-or di-ester of pentaerythritol.

5. The thixotropic composition of any one of claims 1-4, wherein the compatibilizing agent is from 0.1 to 5.0 wt. %.

6. A thixotropic composition for protecting an agricultural product from dehydration and/or oxidation, comprising:
(a) at least one hydrophobically-modified smectite clay;
(b) an oil and/or wax; and
(c) a solvent, comprising a volatile solvent.

7. The thixotropic composition of claim 6, wherein the hydrophobic smectite clay is from 1 to 10 wt. %, optionally from 1 to 5 wt. %.

8. The thixotropic composition of claim 6 or claim 7, wherein the at least one hydrophobically-modified smectite clay is hydrophobically-modified montmorillonite, Laponite, bentonite, hectorite, or saponite; or a mixture of any two of more thereof.

9. The thixotropic composition of any one of claims 1-8, wherein the oil and/or wax comprises an oil and/or wax derived from a plant, optionally wherein the oil is a vegetable or nut oil; or wherein the wax comprises carnauba wax or beeswax.

10. The thixotropic composition of any one of claims 1-9, wherein the oil and/or wax is from 1 to 10 wt. %, optionally from 1 to 5 wt. %.

11. The thixotropic composition of any one of claims 1-10, wherein the solvent is at least 85 wt. %, optionally from 85 to 97.9 wt. %.

12. The thixotropic composition of any one of claims 1-11, wherein the solvent comprises or consists of ethanol; or wherein the solvent is a mixture of ethanol and water, optionally wherein the mixture comprises 25 vol % volatile solvent and 75 vol % water.

13. The thixotropic composition of any one of claims 1-12, wherein the composition is edible.

14. A method of making a thixotropic composition, comprising mixing under high shear smectite clay, a compatibilizing agent for hydrophobically-modifying the clay, oil and/or wax, and a solvent comprising a volatile solvent.

15. A method of making a thixotropic composition, comprising:
(a) dispersing smectite clay in water;
(b) mixing a compatibilizing agent into the smectite clay in water under high shear to hydrophobically-modify the smectite clay;
(c) filtering the hydrophobic smectite clay;
(d) drying the hydrophobic smectite clay;
(e) grinding the dried hydrophobic smectite clay to form a powdered hydrophobic smectite clay;
(f) mixing the powdered hydrophobic smectite clay under high shear with oil and/or wax; and
(g) adding a solvent comprising a volatile solvent.

16. The method of claim 15, wherein the smectite clay is dispersed in water to form a 1 to 5 wt. % dispersion.

17. A method of making a thixotropic composition, comprising:
(a) wetting smectite clay with water;
(b) adding a compatibilizing agent to the wetted smectite clay in a kneading machine equipped with an extruder head to hydrophobically-modify the smectite clay;
(c) extruding the hydrophobic smectite clay through the extruder head to form hydrophobic smectite clay pellets;
(d) drying the hydrophobic smectite clay pellets;
(e) grinding the dried hydrophobic smectite clay pellets to form a powdered hydrophobic smectite clay;
(f) mixing the powdered hydrophobic smectite clay under high shear with oil and/or wax; and
(g) adding a solvent comprising a volatile solvent.

18. The method of claim 17, wherein the wetted smectite clay is 30-90 wt. % smectite clay, optionally about 85 wt. % smectite clay.

19. The method of claim 17 or 18, wherein the kneading machine is a pug mill.

20. The method of any one of claims 15-19, wherein step (e) further comprises sieving the powdered hydrophobic smectite clay.

21. The method of any one of claims 14-20, wherein the smectite clay is from 1 to 10 wt. % in the thixotropic composition; optionally, from 1 to 5 wt. % in the thixotropic composition.

22. The method of any one of claims 14-21, wherein the compatibilizing agent is from 0.1 to 5.0 wt. % in the thixotropic composition.

23. The method of any one of claims 14-22, wherein the oil or wax is from 1 to 10 wt. % in the thixotropic composition; optionally from 1 to 5 wt. % in the thixotropic composition.

24. The method of any one of claims 14-23, wherein the solvent is at least 85 wt. % in the thixotropic composition; optionally between 85 to 97.9 wt. % in the thixotropic composition.

25. The method of any one of claims 14-24, wherein the smectite clay is montmorillonite, Laponite, bentonite, hectorite, or saponite; or a mixture of any two or more thereof.

26. The method of any one of claims 14-25, wherein the compatibilizing agent comprises sodium citrate; or wherein the compatibilizing agent comprises a mono-or di-glyceride of a natural fat and/or a mono-or di-ester of pentaerythritol.

27. The method of any one of claims 14-26, wherein the oil and/or wax comprises an oil and/or wax derived from a plant, optionally wherein the oil is a vegetable or nut oil; or wherein the wax comprises carnauba wax or beeswax.

28. The method of any one of claims 14-27, wherein the solvent comprises or consists of ethanol; or wherein the solvent is a mixture of ethanol and water; optionally wherein the mixture comprises 25 vol % volatile solvent and 75 vol % water.

29. A thixotropic composition prepared by the method of any of claims 14-28.

30. A method of applying a thixotropic composition to an agricultural product or its packaging material, comprising:
making a thixotropic composition according to any one of claims 14-28; and
applying said thixotropic composition to a hydrophobic surface of an agricultural product or its packaging material using a dip tank, spray bar, or brush bed, or any combination thereof.

31. The method of claim 30, wherein the thixotropic composition is applied using a combination of a spray bar and brush bed, or using a combination of a dip tank and brush bed.

32. A method of protecting a packaging material from oxygen ingress and/or moisture loss through the packaging material, comprising applying the thixotropic composition of any one of claims 1-13 or 29 to a hydrophobic surface of the packaging material.

33. A method of protecting an agricultural product from dehydration and/or oxidation, comprising applying the thixotropic composition of any one of claims 1-13 or 29 to a hydrophobic surface of the agricultural product.

34. A method of improving shelf-life of an agricultural product, comprising applying the thixotropic composition of any one of claims 1-13 or 29 to a hydrophobic surface of the agricultural product.

35. A method of protecting an agricultural product from dehydration and/or oxidation, or for improving the shelf-life of an agricultural product, comprising applying the thixotropic composition of any one of claims 1-13 or 29 to a hydrophobic surface of a packaging material intended for packaging the agricultural product;
optionally, wherein the method further comprises packaging the agricultural product in the packaging material.

36. A method of protecting an agricultural product from dehydration and/or oxidation, or for improving the shelf-life of an agricultural product, comprising applying the thixotropic composition of any one of claims 1-13 or 29 to a hydrophobic surface of a packaging material enclosing the agricultural product.

37. The method of any one of claims 33-36, wherein the agricultural product is produce, such as fruit or vegetable produce, or wherein the agricultural product is cut flowers.

38. The method of any one of claims 32-37, wherein the thixotropic composition is applied using a spray bar, dip tank, brush bed, ink jet printing, gravure, or doctor knife, or a combination thereof.

39. The method of claim 38, wherein the thixotropic composition is applied using a combination of a spray bar and brush bed.

40. The method of claim 38, wherein the thixotropic composition is applied using a combination of a dip tank and brush bed.

41. Use of the thixotropic composition of any one of claims 1-13 or 29, for protecting an agricultural product having a hydrophobic surface from dehydration and/or oxidation.

42. Use of the thixotropic composition of any one of claims 1-13 or 29, for improving the shelf-life of an agricultural product having a hydrophobic surface.

43. Use according to claim 41 or 42, wherein the agricultural product is produce, such as fruit or vegetable produce, or wherein the agricultural product is cut flowers.

44. Use of the thixotropic composition of any one of claims 1-13 or 29, for protecting a packaging material from oxygen ingress and/or moisture loss through the packaging material.
